(19) United States
(12) Patent Application Publication
(10) Pub. No.: US 2004/0144731 A1
(43) Pub. Date: Jul. 29, 2004

(54) Process for treatment of mineral clay slurry

(76) Inventors: Ronald F. Hartung, Lakeland, FL (US); John M. Keating, Mulberry, FL (US); T. Michael Chancey, Lakeland, FL (US)

Correspondence Address: SIDLEY AUSTIN BROWN & WOOD LLP, 717 NORTH HARWOOD, SUITE 3400, DALLAS, TX, 75201, US

(21) Appl. No.: 10/719,178

(22) Filed: Nov. 21, 2003

Related U.S. Application Data
(60) Provisional application No. 60/428,433, filed on Nov. 22, 2002.

(51) Int. Cl. C02F 1/52

(52) U.S. Cl. 210/723

(57) ABSTRACT

A method for separating suspended clay fines from water in a mining clay slurry is disclosed. The method comprises injecting simultaneously the clay slurry, a polymeric flocculating agent, and optionally, dilution water directly into a clay settling area (CSA), flocculating the clay fines in the CSA, and sedimenting the flocculated clay to form a thickened clay and a supernatant fluid. The method can further comprise recycling the supernatant fluid as mining process water or dilution water. The method can further comprise transferring the thickened clay from the CSA into one or more additional CSAs. The polymeric flocculating agent can be added either as an aqueous solution or as dry chemical.

### CROSS REFERENCE TO RELATED APPLICATION

This application claims benefit to U.S. Provisional Application No. 60/428,433 filed Nov. 22, 2002, which is hereby incorporated by reference.

### TECHNICAL FIELD OF INVENTION

The invention relates to processes for separating suspended solid particles or fines from liquids by sedimentation using a polymeric flocculating agent.

### BACKGROUND OF THE INVENTION

Mineral fines such as aqueous clay slurries are routinely formed during mineral mining processes. For example, in the mining of phosphate ore or matrix (consisting essentially of phosphate, sand, and clay), the phosphate matrix is generally washed with high pressure water to form a matrix slurry. The matrix slurry then undergoes phosphate beneficiation in a concentrating process wherein the larger phosphate particles are first screened from the matrix slurry; then, using equipment such as hydro-cyclones, a clay slurry consisting essentially of about 2% to 7% solids of fine clay particles of less than 150 mesh (diameter of 106 microns) in water is removed from the matrix slurry; and finally, the remaining matrix slurry is treated in a flotation process using chemicals, water, and physical force to separate phosphate, sand, and any remaining clay particles.

In disposal of the clay slurries (e.g., phosphatic clays) obtained in the washing and flotation processes, the clay slurries are normally sent to a clay settling area (CSA) to allow the clay to separate by gravity from the aqueous supernatant fluid, wherein the clay settles to the bottom and the aqueous supernatant fluid remains on top. The aqueous supernatant fluid can then be decanted from the top of the CSA and recycled for reuse in the mining and beneficiation processes.

With gravity alone, the clay sedimentation rate is very slow, and the separation process for removing the supernatant fluid from the clay requires CSAs of large surface area. For example, a typical mining operation can utilize many CSAs with 500 to 1000 acres of surface area. Therefore, methods to increase the clay sedimentation rate and/or reduce the amount of required CSA acreage are advantageous.

Several methods for accelerating the clay sedimentation rate and/or reducing the amount of CSA acreage have been reported. One method commonly used to accelerate the clay sedimentation rate involves the use of flocculating agents, chelating agents, and/or coagulating agents. For example, U.S. Pat. Nos. 3,418,237; 3,622,087; 3,680,698; 3,707,523; 3,932,275; 4,049,547; 4,194,969; 4,224,149; 4,251,363; 4,265,770; 4,342,653; 4,555,346; 4,690,752; 5,178,774; 5,688,404; and 6,077,441 disclose adding such agents to clay slurries to enhance the rate at which water is removed from the clay slurries generated in ore processing operations.

U.S. Pat. No. 3,763,041 discloses admixing waste tailings consisting essentially of sand to waste slimes to enhance the rate at which water is removed from the waste slimes and to produce a fertile soil once the water is removed.

U.S. Pat. No. 5,688,404 discloses a process in which a water soluble polymeric cationic flocculant is added to a mining waste aqueous stream to accelerate the sedimentation of waste slime (clay) in a sedimentation area while recoverable phosphate feed particles in the waste aqueous stream remain unflocculated and recoverable. The waste stream flows through a settling zone where recoverable phosphate feed particles can be removed before entering a sedimentation area.

U.S. Pat. No. 5,178,774 discloses a process of separating coagulatable material from an aqueous suspension of coagulatable material such as an aqueous coal tailing or mineral suspension, wherein a solid water soluble ionic polymeric coagulant is added to the aqueous suspension of coagulatable material, the polymer particles dissolve in the suspension thereby coagulating the coagulatable material, and the coagulated suspension is subjected to a separation process. For example, a counterionic high molecular weight flocculant can be added to flocculate the coagulated material.

U.S. Pat. No. 6,077,441 discloses a mineral recovery process comprising a main separation stage in which a mineral is slurried with water and separated into an enriched fraction and a dilute aqueous clay waste; and a waste sedimentation stage in which the dilute aqueous clay waste is first fed into a well and flocculated by mixing a polymeric flocculant into the dilute aqueous clay waste thus providing a pumpable thickened clay sediment layer in the well and a supernatant layer, and wherein the thickened clay sediment layer is pumped from the well into one or more settling lagoons to provide a substantially solid clay sediment and a supernatant and the supernatant layer is recycled from the well back into the main separation stage.

While flocculating agents were utilized in these treatment processes to accelerate the clay sedimentation rate, special steps and/or treatment facilities were required. For example, various procedures and facilities such as mixing steps and separation steps as well as mixing pits, settling zones, and thickening wells or pits were used singly or in combinations to improve clay sedimentation rates and reduce the amount of required CSA acreage.

Novel treatment processes have now been found which provide rapid separation of water from the clay slurries produced during mineral mining. In these processes, the clay slurries and an aqueous polymer solution are injected directly into a CSA where the clay solids rapidly settle out to permit timely recycling of the aqueous supernatant fluid.

### SUMMARY OF THE INVENTION

In one aspect, the invention is a method for separating suspended clay fines from water in a mining clay slurry comprising injecting simultaneously the clay slurry, a polymeric flocculating agent, and optionally, dilution water directly into a CSA, flocculating the clay fines in the CSA, and sedimenting the flocculated clay to form a thickened clay and a supernatant fluid. The method can further comprise recycling the supernatant fluid as mining process water or dilution water. The method can further comprise transferring the thickened clay from the CSA into one or more additional CSAs. The polymeric flocculating agent can be added either as an aqueous solution or as dry chemical. Preferred flocculating agents include acrylamide-sodium acrylate copolymers.

In another aspect, the invention is a method for separating suspended clay fines from water in a mining clay slurry comprising injecting the clay slurry directly into a CSA and subsequently injecting a polymeric flocculating agent and optionally, dilution water directly into the CSA, flocculating the clay fines in the CSA, and sedimenting the flocculated clay to form a thickened clay and a supernatant fluid. The method can further comprise recycling the supernatant fluid as mining process water or dilution water. The method can further comprise transferring the thickened clay from the CSA into one or more additional CSAs. The polymeric flocculating agent can be added either as an aqueous solution or as dry chemical. Preferred flocculating agents include acrylamide-sodium acrylate copolymers.

### BRIEF DESCRIPTION OF DRAWINGS

FIG. 1 depicts a treatment method wherein the clay slurry, dilution water and polymer are all added into the CSA at one introduction point all at the same time, with the thickened clay transferred to a second CSA and supernatant fluid being recycled as mining and plant process water and as dilution water.

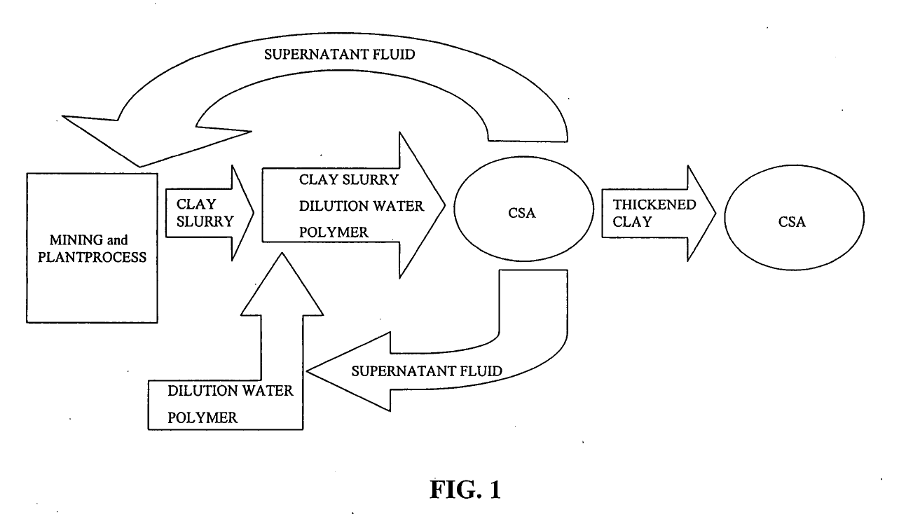

FIG. 2 depicts a treatment method wherein the clay slurry is added into the CSA at one introduction point and the dilution water with polymer are added at another introduction point, and with the thickened clay transferred to a second CSA and supernatant fluid being recycled as mining and plant process water and as dilution water.

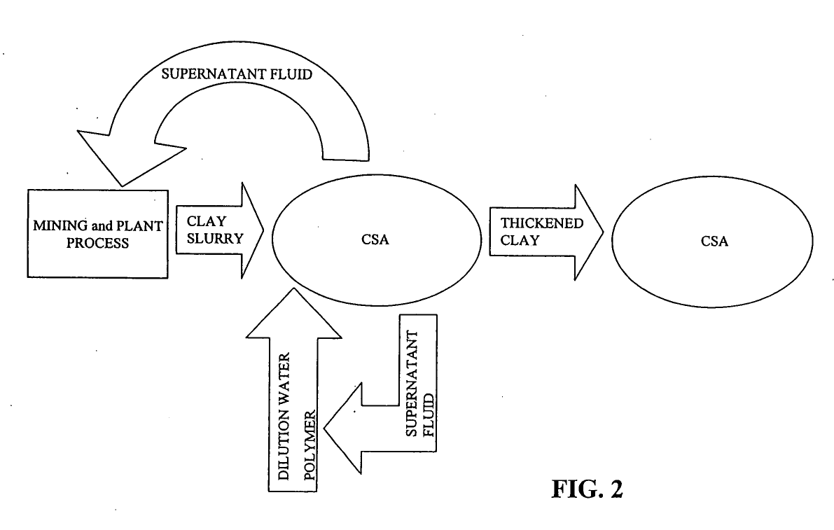

### DETAILED DESCRIPTION

The treatment processes of the present invention comprise the injection of mineral fines such as a clay slurry from the mining of a phosphate matrix, dilution water, if necessary, and a polymeric flocculating agent directly into a conventional CSA without the need for a separate mixing pit or thickening well. The polymer causes the solid clay particles to agglomerate, and the resulting flocculated solids settle in the CSA at a greatly increased rate downstream from the injection site. The thickened clay solids can be optionally removed from the CSA by pumping from the bottom of the CSA, preferably at a point downstream from the injection site. The supernatant fluid can be removed by any means known in the art for removal of fluids from the top layer of the CSA, for example, by pumping, siphoning or use of a spillway or weir. The supernatant fluid can then be recycled for reuse in the beneficiation process or for use as dilution water in the treatment process.

Clay slurries generally comprise about 2% to 7% total solids by weight but may contain less solids. The solids are generally composed of clay fines of less than 150 mesh; however, some coarser particles may be present. The amount of clay fines in the clay slurries requires sedimentation and removal of the aqueous phase to convert the clay fines into a solid substance. The treatment processes of the present invention can be utilized for a clay slurry injected directly from the mining operation into a CSA. In another aspect, the treatment process can be utilized for a clay slurry which has been transported to a remote CSA.

Optionally and preferentially, dilution water can be added to the clay slurry to achieve the optimum clay density for the polymer addition. The amount of dilution water to be added can be determined by measuring the flow rate and percent solids of the dilute clay stream prior to discharging into the CSA and adjusting the volume of dilution water to achieve the desired clay slurry density. A preferred clay density upon discharge into a CSA is from about 1% total solids by weight to about 1.25% total solids by weight.

At least one water soluble polymeric flocculating agent capable of flocculating the clay fines in the clay slurry into a thickened clay solid is required in the treatment processes of the present invention. The water soluble polymeric flocculating agent(s) can be added to the clay slurry as a dry chemical or as an aqueous polymeric solution prior to injection of the clay slurry into the CSA, or the aqueous polymeric solution can be separately injected into the CSA after addition of the clay slurry to the CSA.

In a preferred method, the polymer is in an aqueous solution upon addition to the CSA. Dry polymer is mixed with water to create a low concentration polymer solution. This dilute polymer solution is preferably mixed in tanks for a period of time adequate to allow the polymer chain to elongate before it is transported to the clay slurry introduction point in the CSA. The low concentration polymer solution is then added to the dilution water stream prior to its introduction into the CSA to provide the maximum volume for the polymer to disperse into prior to coming into contact with the clay particles.

In another preferred method, dry polymer is added at the introduction point of the dilute clay slurry stream into the CSA. While the efficiency of the polymer to flocculate the clay fines is generally reduced when the polymer is added to the dilute clay stream in a dry state, this method has the advantage of foregoing the premixing step to form a dilute polymer solution prior to introduction into the clay stream.

Any water soluble polymeric flocculant known in the art to promote separation of the clay slurry into a supernatant and a thickened clay sediment can be used in the treatment methods of the present invention. Preferably, the polymer is a water soluble polymer formed from one or more ethylenically unsaturated monomers which can be anionic, cationic or non-ionic. Suitable anionic monomers include but are not limited to ethylenically unsaturated monomers such as acrylic acid, methacrylic acid and 2-acrylamido-2-methylpropane sulfonic acid. Suitable non-ionic monomers include but are not limited to acrylamide. Suitable cationic monomers include but are not limited to dialkylaminoalkyl-methacrylates, dialkylaminoalkyl-methacrylamides or diallyldimethylammonium chloride. Suitable polymers can be anionic, cationic or non-ionic. Preferred polymers include but are not limited to acrylamide-acrylic acid copolymers and their derivatives, and in particular, anionic acrylamide-acrylic acid copolymers. A preferred acrylamide-acrylic acid copolymer is CIBA 336 (Ciba Specialty Chemicals, Tarrytown, N.Y.), which is an effective flocculating agent when added wet or dry over a range of concentrations.

In a preferred method, a copolymer of sodium acrylate and acrylamide is used in the concentration range of from about 0.2 pounds of 100% polymer per ton of dry clay to about 1.2 pounds of 100% polymer per ton of dry clay. An initial aqueous solution of copolymer is made in the concentration range of from about 0.2% dry polymer in water to about 0.6% dry polymer in water. The initial aqueous solution is then further diluted by addition or injection of the initial aqueous solution into a continuous water flow or feed solution such as the dilution water stream prior to the introduction point of the CSA. Thus, the concentration of copolymer in the feed solution can be variably controlled by increasing or decreasing the amount of initial aqueous solution being added to the feed solution. This method of control is useful in minimizing the amount of copolymer consumption per ton of dry clay.

Upon flocculation of the clay fines into thickened clay solids and the supernatant fluid, the supernatant is preferably removed from the CSA for recycling, e.g., as water for the mining process or as incoming clay stream dilution water. The thickened clay solids can be left in the CSA for further gravitational settling. Preferably, the thickened clay solids are transferred from the initial flocculant treated CSA into one or more CSAs for further settling.

The treatment processes of the present invention provide advantages over the use of gravitational sedimentation methods. By using a flocculating agent to quickly separate the clay from the aqueous supernatant fluid, the supernatant fluid can be recycled back into the mining process, and thus, allow the mining operation to reduce the amount of new water input from sources such as rain and deep wells. The aqueous supernatant fluid will have predictably low turbidity within a few minutes after separating from the flocculating clay slurry. Low turbidity supernatant fluid, when recycled to use as incoming clay stream dilution water, reduces polymer consumption by decreasing the amount of additional polymer needed when the recycled clay stream dilution water is again introduced into the CSA. Low turbidity supernatant fluid, when used as process water, reduces mineral processing costs. The polymer treated flocculated clay material also consolidates to a higher density faster than untreated clay slurries, allowing more tons of clay to be stored in a given volume of CSA. When clay must be transported over long distances to storage, treated clay costs less to transport than untreated dilute clay slurry as a large portion of the water has been removed.

Further, the treatment processes of the present invention provide advantages over other polymer-based treatment processes known in the art. Because the clay slurry along with the polymeric flocculant go directly into the CSA, the need for other facilities such as mixing pits and thickening wells or pits is eliminated. This is especially advantageous for mining locations where the amount of available acreage for clay treatment and storage is limited. Occasionally, the rate of clay slurry arriving at the treatment area increases beyond the ability of the polymer treatment system to properly dose the incoming tonnage. Treatment in a CSA allows the poorly flocculated clay particles to migrate into the vast area of the CSA to settle until the over-capacity condition dissipates. This process allows for a tremendous amount of surge capacity. Also, during a treatment system overload, high suspended solids supernatant can be produced. Containing this fluid in the vast area of the CSA gives it time to settle the poorly flocculated clay particles before it is used for dilution water or mining and plant process water.

### EXAMPLE 1

### Exemplary Treatment Process Run

In one treatment process run, an initial aqueous solution of a sodium acrylate-acrylamide copolymer was made by mixing dry copolymer in water to a solution strength of 0.4% copolymer by weight. Approximately 400 gallons per minute (GPM) of the initial aqueous solution was added to the 225,000 GPM dilution water stream. At the introduction point to the CSA, 1100 tons per hour of clay slurry was injected into the CSA at 150,000 GPM, while the copolymer-containing dilution water stream was simultaneously injected into the CSA at 225,000 GPM. After 48 settling hours, the 125,000 GPM of supernatant fluid were recovered.

What is claimed is:

1. A method for separating suspended clay fines from water in a clay slurry comprising:
injecting the clay slurry into a clay settling area at an introduction point; and
injecting, into the clay settling area at the introduction point, a polymeric flocculating agent, the polymeric flocculating agent causing clay fines in the clay slurry to flocculate and settle in the clay settling area, the flocculated clay sedimenting to form a thickened clay and a supernatant fluid in the clay settling area.

2. A method in accordance with claim 1, further comprising injecting dilution water directly into the clay settling area at the introduction point, the dilution water mixing with the clay slurry to form a dilute clay stream prior to discharging into the clay settling area.

3. A method in accordance with claim 2, wherein the dilution water comprises supernatant fluid extracted from the clay settling area.

4. A method in accordance with claim 2, further comprising:
measuring a flow rate of the dilute clay stream prior to discharging into the clay settling area;
measuring a percent solids of the dilute clay stream prior to discharging into the clay settling area; and
adjusting the volume of the dilution water based on the flow rate and the percent solids of the dilute clay stream to achieve a desired clay slurry density upon discharge into the clay settling area.

5. A method in accordance with claim 4, wherein the desired clay slurry density is between about 1% and about 1.25% total solids by weight.

6. A method in accordance with claim 1, wherein the step of injecting the polymeric flocculating agent includes:
mixing the polymeric flocculating agent with water to create a polymer solution; and
injecting the polymer solution into clay settling area at the introduction point.

7. A method in accordance with claim 6, wherein the step of injecting the polymer solution into the clay settling area is performed contemporaneously with the step of injecting the clay slurry into the clay settling area.

8. A method in accordance with claim 6, wherein the step of injecting the polymer solution into the clay settling area is performed subsequent to the step of injecting the clay slurry into the clay settling area.

9. A method in accordance with claim 1, wherein the step of injecting the polymeric flocculating agent includes injecting a dry chemical form of the polymeric flocculating agent directly into the clay settling area.

10. A method in accordance with claim 1, wherein the polymeric flocculating agent is a water soluble polymer formed from at least one ethylenically unsaturated monomer.

11. A method in accordance with claim 10, wherein the ethylenically unsaturated monomer is a monomer selected from the group consisting of:
an anionic monomer;
a non-anionic monomer; and
a cationic monomer.

12. A method in accordance with claim 10, wherein the ethylenically unsaturated monomer is selected from the group consisting of:
acrylic acid;
methacrylic acid;
2-acrylamido-2-methylpropane sulfonic acid;
acrylamide;
dialkylaminoalkyl-methacrylates;
dialkylaminoalkyl-methacrylamides; and
diallyldimethylammonium chloride.

13. A method in accordance with claim 1 wherein the flocculating agent is a polymer selected from the group consisting of:
an anionic polymer;
a cationic polymer; and
a non-ionic polymer.

14. A method in accordance with claim 1 wherein the polymeric flocculating agent is an acrylamide-acrylic acid copolymer.

15. A method in accordance with claim 1, wherein the polymeric flocculating agent is a copolymer of sodium acrylate and acrylamide.

16. A method in accordance with claim 15, wherein a concentration of the polymeric flocculating agent is between about 0.2 to about 1.2 pounds of 100% polymer per ton of dry clay.

17. A method in accordance with claim 1, further comprising pumping the thickened clay from a bottom of the clay settling area at a point downstream of the introduction point.

18. A method in accordance with claim 17, further comprising transferring the thickened clay from the clay settling area into another clay settling area for further settling.

19. A method in accordance with claim 1, further comprising removing the supernatant fluid from a top layer of the clay settling area.

20. A method in accordance with claim 19, wherein the step of removing the supernatant fluid includes a step selected from the group consisting of:
pumping the supernatant fluid from a top layer of the clay settling area;
siphoning the supernatant fluid from a top layer of the clay settling area;
using a spillway to remove the supernatant fluid; and
using a weir to remove the supernatant fluid.

21. A method for separating suspended clay fines from water in a clay slurry comprising:
injecting the clay slurry into a clay settling area at an introduction point;
mixing a copolymer of sodium acrylate and acrylamide with water to form an initial polymer solution containing between about 0.2% to about 0.6% dry polymer in water;
injecting the initial polymer solution into a water stream to form a feed solution; and
injecting the feed solution into the clay settling area at the introduction point, the polymer in the feed solution causing clay fines in the clay slurry to flocculate and settle in the clay settling area, the flocculated clay sedimenting to form a thickened clay and a supernatant fluid in the clay settling area.
